(19) United States
(12) Patent Application Publication
(10) Pub. No.: US 2002/0143951 A1
(43) Pub. Date: Oct. 3, 2002

(54) Method and system for multicast to unicast bridging

(75) Inventors: Shahadatulla Khan, North Vancouver (CA); Christopher Piche, West Vancouver (CA)

Correspondence Address: KENYON & KENYON, ONE BROADWAY, NEW YORK, NY, 10004, US

(73) Assignee: Eyeball.com Network Inc.

(21) Appl. No.: 09/822,060

(22) Filed: Mar. 30, 2001

(51) Int. Cl. G06F 15/16

(52) U.S. Cl. 709/227; 709/205; 370/390

(57) ABSTRACT

The present invention relates to a method and a system for sending multicast information to a user. The present uses agents, network programs, that reside on multicast-enabled computers. The agents receive multicast data packets sent to members of a multicast group. The agents repackage the multicast information into a unicast data packet and forward the unicast data packet to a client registered with the agent. The agent may maintain a list of clients for whom it provides service along with information on the multicast group(s) from which the client wants to receive information. Clients may register with an agent by sending a join message. In one embodiment of the present invention, the join message is sent to a source server, another computer program, that handles the assignment of clients to agents. The source server may maintain and/or generate information concerning client/agent pairings that may be used in the assignment process. For example, a composite distance metric calculating some value such as latency or distance between a client and an agent (a client/agent pair) may be used. In another embodiment of the present invention, the client may register directly with an agent. In this embodiment, the agent to which the client sends the join message to may become the agent providing the multicasting-to-unicast bridging services to the client. In a third embodiment of the present invention, the client may send a join message to an agent, where this first agent may be termed a primary agent. The primary agent may determine the agent responsible for providing service to the client (which may be termed the service provider agent). The primary agent may maintain/or generate client/agent pair information such as the composite distance metric to assist with client/service provider agent pairing. Unlike the source server, in this embodiment one to all of the agents may serve as a primary agent and all the primary agents may also function as service provider agents. The source server, the client(s), and the agent(s) may be distributed over several computer systems connected over a communications network such as the Internet.

### FIELD OF THE INVENTION

The present invention relates to a method and system for sending a transmitted multicast packet stream to a unicast client.

### BACKGROUND INFORMATION

Most information networks employ three general modes of communication: broadcast, unicast, and multicast. Broadcast communication is the transmission of information from a sender (i.e., a single point) to all recipients (i.e., all points) over the communications network (i.e., one-to-all or point-to-all transmission). Broadcast transmission is available over most local area networks (LANs) but is not available on the Internet. Unicast communication is the transmission of information from a sender (i.e., a single point) to a recipient (i.e., a single point) over the communications network (i.e., one-to-one or point-to-point transmission). Multicast communication is the transmission of information from one or more senders (i.e., many points) to many recipients (i.e., many points) over the communications network (i.e., many-to-many or point-to-many transmission). Unlike broadcast transmission, both unicast and multicast transmission are available over the Internet and most communications networks. Though unicast transmission is the traditional communications mode, multicast transmission is more suitable for the higher bandwidth multimedia applications such as video conferencing and video distribution that are achieving increasingly greater utilization over communications networks, in particular the Internet.

For a unicast transmission, if a source (i.e., the sender) wants several recipients to receive the information being transmitted, a separate transmission may need to be sent to each recipient. For example, if a source (e.g., source A) wants to send information to a recipient (e.g., recipient X), one unicast transmission of the information needs to be made (i.e., a transmission to recipient X). In another example, if a source (e.g., source A) wants to send the same information to three different recipients (e.g., recipients X, Y, and Z), three separate unicast transmissions of the information may need to be made (i.e., one transmission each to recipients X, Y, and Z, may be necessary). FIG. 1a is a block diagram illustrating the unicast transmission of information. Sender 105 separately transmits information (e.g., a data stream or video stream) organized in unicast data packets to each recipient 110a- 110e. Unicast transmission is still the predominant mode of transmission on local area networks (LANs) and on the Internet. IP (Internet Protocol) networks and LANs (e.g., Ethernet) support the unicast transmission mode necessary for such well known unicast protocols as the HyperText Transport Protocol (HTTP), Simple Mail Transport Protocol (SMTP), and File Transport Protocol (FTP).

FIG. 2 is a block diagram illustrating, in greater detail, an example of the unicast transmission of data over a communications network such as the Internet according to one conventional embodiment. A unicast transmission begins with a sender deciding to transmit information over the communications network. In the conventional embodiment illustrated in FIG. 2, video distribution 205a and video-on-demand 205b are shown as nonexclusive examples of the types of information that may be included in a unicast transmission. Video distribution 205a and video-on-demand 205b are examples of more recent multimedia data that, when sent as unicast transmissions to many recipients, may use considerable resources on the communications network. The source sends a unicast transmission through a server computer 210 over a communications network. FIG. 2 illustrates the unicast transmission of video distribution 205a and video-on-demand 205b to three recipients 220a-220c over an intranet/LAN 235 and four recipients 230a-230d over the Internet 240. As stated earlier, a separate unicast transmission must be made for each recipient because of the point-to-point nature of unicast. Therefore, seven separate unicast transmissions must be made. The first three unicast transmissions are made to the three recipients 220a-220c on the local intranet/LAN 235 and are illustrated by the lines directly connecting the server computer 210 to each of the intranet/LAN clients 220a-220c. The next four unicast transmissions are made to the four recipients 230a-230d on the Internet 240 and are illustrated by the four lines connecting the server computer 210 with a router 225a on the local intranet/LAN 235. These four unicast transmissions, still shown as individual lines, are then sent by the local router 225a to a second router 225b on the Internet 240. The second router 225b may then forward each transmission to a recipient or to another router for further forwarding. FIG. 2 shows one of the unicast transmissions being forwarded by the second router 225b directly to an Internet recipient 230a while the remaining three are forwarded to a third router 225c. The third router 225c then forwards the remaining three unicast transmissions individually to their respective recipients 230b-230d.

Multicast is the transmission mechanism whereby one or more senders may transmit information to a group of one or more recipients (many-to-many transmission) in a manner more efficient than multiple unicast transmissions. If a sender of a multicast transmission wants several recipients to receive the data being transmitted, the source (i.e., the sender) makes only a single transmission to a group of recipients. For example, if a video server is transmitting a television channel to recipients X, Y, and Z, all connected to the same Internet node, a single transmission from the video server to the Internet node is required compared with three separate transmissions required for a unicast transmission. Multicasting is the delivery of that single transmission simultaneously to a group of clients (in the example above, X, Y, and Z). FIG. 1b is a block diagram illustrating the multicast transmission of information. Sender 115 transmits information organized in multicast data packets over a communications network with the data being received by all members of the multicast group (recipients) 120a-120e. IP multicast packets are identical to IP unicast packets except that the multicast packets use special destination addresses for the multicast group. Multicast differs from broadcast transmission because a client only receives multicast packets from a multicast group if it has previously chosen to do so. Multicast group membership is also dynamic with the routers learning which subnetworks have active clients for each multicast group and routing the multicast transmission according to this information stored in a routing table of the router.

FIG. 3 is a block diagram illustrating an example of the multicast transmission of data over a communications network such as the Internet according to one conventional embodiment. A multicast transmission begins with a sender deciding to transmit information over the communications network. In the conventional embodiment illustrated in FIG. 3, video conferencing 355a and video distribution 355b are shown as nonexclusive examples of the types of information that may be included in a multicast transmission. The source sends a multicast transmission through a server computer 360 over a communications network. FIG. 3 illustrates the multicast transmission of video conferencing 355a and video distribution 355b to three recipients 370a-370c over an intranet/LAN 385 and four recipients 380a-380d over the Internet 390. Unlike unicast as previously discussed, a multicast transmission is made only once to each intermediate system (e.g., a router and a server) that has a multicast group member (i.e., client) connected to it (e.g., attached to a subnetwork of the router). Once the multicast transmission reaches an intermediate system, the multicast clients connected to the intermediate may receive the multicast information. For example, the first multicast transmission is made by the server 360 to the router 375a on the intranet/LAN 385. The router 375a may determine that several clients attached to its subnetworks belong to the multicast group of the multicast transmission, in this case three client 370a-370c. The router 375a will then forward to these clients 370a-370c the multicast packets making up the multicast transmission. The router 375a will also continue forwarding the multicast message to other intermediate systems using conventional means. In this example, the first router 375a forwards the multicast transmission to a second router 375b on the Internet 390. Like the first router 375a, the second router 375b may determine whether any clients attached to its subnetworks belong to the multicast group of the transmission. In FIG. 3, the second router 375b has one attached multicast client 380a to whom it may forward the multicast information. The second router 375b also forwards the multicast transmission to a third router 375c. The third router 375c finds three multicast clients 380b-380d attached to its subnetworks who are members of the multicast group of the transmission. The third router 375c may forward the multicast information to these three clients 380b-380d.

Unlike the unicast transmission example shown in FIG. 2, multicast transmission reduces the bandwidth used by reducing the information sent between intermediate systems. This reduction is accomplished by, in essence, sharing a single transmission instead of redundantly sending a copy of each data packet in the transmission to each recipient along the entire transmission path. Comparing FIG. 3 with FIG. 2 highlights the reduced traffic between the server 210, 360 and the first router 225a, 375a, between the first router 225a, 375a and the second router 225b, 375b, and between the second router 225b, 375b and the third router 225c, 375c.

The MBone (Multicast Backbone) is a virtual network built on top of the Internet that supports the routing of multicast packets. The MBone is comprised of interconnected multicast routers spanning the Internet. IP multicast routers (routers enabled to support multicast transmission over the Internet) support both the Internet Group Management Protocol (IGMP), which allows the router to learn about multicast group members on the router's directly attached subnetworks, and at least one multicast routing protocol, such as Multicast Open Shortest Path First (MOSPF), Core Based Trees (CBT), Distance Vector Multicast Routing Protocol (DVMRP), and both Protocol Independent Multicast (PIM) Sparse Mode (PIM-SM) and Dense Mode (PIM-DM). Many older routers do not support multicast and, therefore, a special mechanism is necessary to send multicast transmissions over these nonmulticast routers (but not to clients on the nonmulticast router's subnetworks). This mechanism is termed “tunneling” and is the process whereby a multicast packet is encapsulated in a unicast packet at a multicast router, the encapsulated packet is transmitted over the older nonmulticast router or routers to a second multicast router, and the second multicast router retrieves the multicast packet from within the unicast packet and continues to forward the multicast packet as necessary. A tunnel is the term describing established tunneling services between two multicast routers. Tunnels are typically set-up manually and are not automatically available between multicast routers. Tunneling does not allow a client attached to a nonmulticast router over which tunneling occurs to receive the tunneled multicast information.

The traditional means for transmitting information over a communications network such as the Internet, unicast transmission, is proving inadequate to handle the increased resource requirements of newer multimedia applications such as video conferencing, video distribution, etc. The advent of these multimedia services exhausts currently available network resources on the Internet and other communications networks and has led to an increase in the use of multicasting. However, the advantages of multicast transmission in reducing network load cannot be fully utilized on current communications systems such as the Internet because multicast is not widely deployed. For example, most of the Internet Service Providers (ISPs) do not support IP multicast. For this reason, an IP multicast application cannot reach the vast majority of Internet clients who are not connected through multicast-enabled ISPs. Furthermore, even though a client is connected to the Internet through a multicast-enabled ISP, the client may not be able to access a multicast stream (transmission) from a server computer because the server computer and the client are part of two separate multicast islands on the Internet with no multicast link (e.g., a tunnel) between them.

The present invention is the only currently available method for bridging multicast and unicast that uses UDP (user datagram protocol) for data distribution. Current research and standardization aims to provide error-free multicast delivery (i.e., extend TCP from two clients to multiple clients). Protocols such as scalable reliable multicast (SRM), active reliable multicast (ARM), reliable multicast transport protocol (RMTP), log-based receiver reliable multicast (LBRM) are all available but focus on error-free delivery over a multicast network. The present invention focuses on multicast data distribution to unicast clients and as such is separate from the concern for error-free delivery over a multicast network.

### SUMMARY OF THE INVENTION

The present invention solves the problem of limited multicast availability by providing a novel method and system for bridging multicast and unicast. The present invention uses network programs termed “agents” that reside on multicast-enabled computers connected to a multicast group to provide bridging services between the multicast group and the unicast clients. The agents may be managed by a source server, which may consist of one or more server programs that handle the designation of which agent is responsible for the bridging services of a unicast client. The source server may also determine if a new agent is needed and may initiate new agent processes as required.

According to one embodiment of the present invention, a unicast client may join a multicast group by sending a join message to the source server. The source server may use a composite distance metric (CDM) calculation to determine if an appropriate agent exists for the unicast client. If no appropriate agent exists, the source server may start a new agent process that is appropriate for the unicast client according to one embodiment of the present invention. Once an appropriate agent is available, the source server may either forward the join message or send a new join message to the designated (appropriate) agent. The agent may then add the client to the agent's recipient list and may send the client a confirmation message. When a multicast packet is broadcast to the multicast group, the agent (which is part of the multicast group) receives the multicast packet, reformats it as a unicast packet and sends the unicast packet to each of the clients in the agent's recipient list for that multicast group. FIG. 1c is a block diagram illustrating the multicast transmission of packets to both multicast-enabled and unicast clients according to one embodiment of the present invention. Sender 125 transmits over a communications network multicast packets that are received by the members of the multicast group (recipients) 130a- 130d, 135. The recipients include an agent process 135. The agent 135 generates unicast packets based on each of the received multicast packets and sends the unicast data to each of the unicast clients 140a- 140e for whom the agent has been designated to provide bridging services for that particular multicast group. There does not need to be a one-to-one mapping of multicast packets to unicast packets though there can be. A client may leave a multicast group by sending the designated agent a leave message which may result in the client being removed from the agent's recipient list for the multicast group.

The source server may continually make composite distance metric calculations between different combinations of agent and client according to one embodiment of the present invention. These calculations may be stored by the source server in a composite metric index which the source server may use when determining if a new agent needs to be initiated and whether a client needs to be rerouted. The composite distance metric calculations may include many different variables such as the load on the agent, the distance between the agent and the client, and other factors deemed necessary to enhance the efficiency of the agent designation and rerouting process.

### BRIEF DESCRIPTION OF THE DRAWINGS

FIG. 1a is a block diagram illustrating the conventional unicast transmission of information.

FIG. 1b is a block diagram illustrating the conventional multicast transmission of information.

FIG. 1c is a block diagram illustrating the multicast transmission of information to both multicast-enabled and unicast clients according to one embodiment of the present invention.

FIG. 2 is a block diagram illustrating the unicast transmission of data over an communications network such as the Internet according to one conventional embodiment.

FIG. 3 is a block diagram illustrating the multicast transmission of data over an communications network such as the Internet according to one conventional embodiment.

FIG. 4 is a diagram illustrating the transmission of a multicast packet or message according to one embodiment of the present invention.

FIG. 5a is a block diagram illustrating the process whereby a unicast client joins a multicast group according to one embodiment of the present invention.

FIG. 5b is a block diagram illustrating the process whereby a unicast client leaves a multicast group according to one embodiment of the present invention.

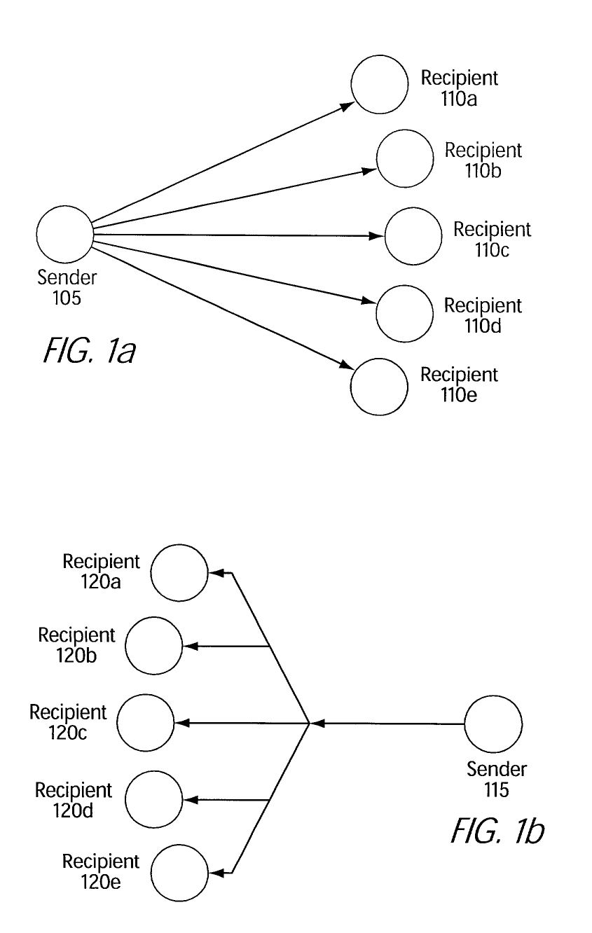

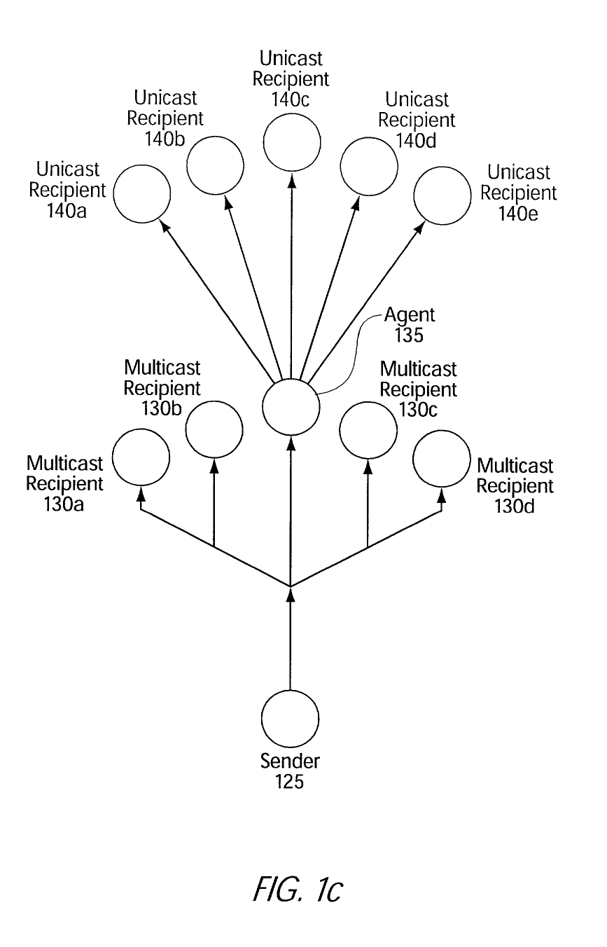

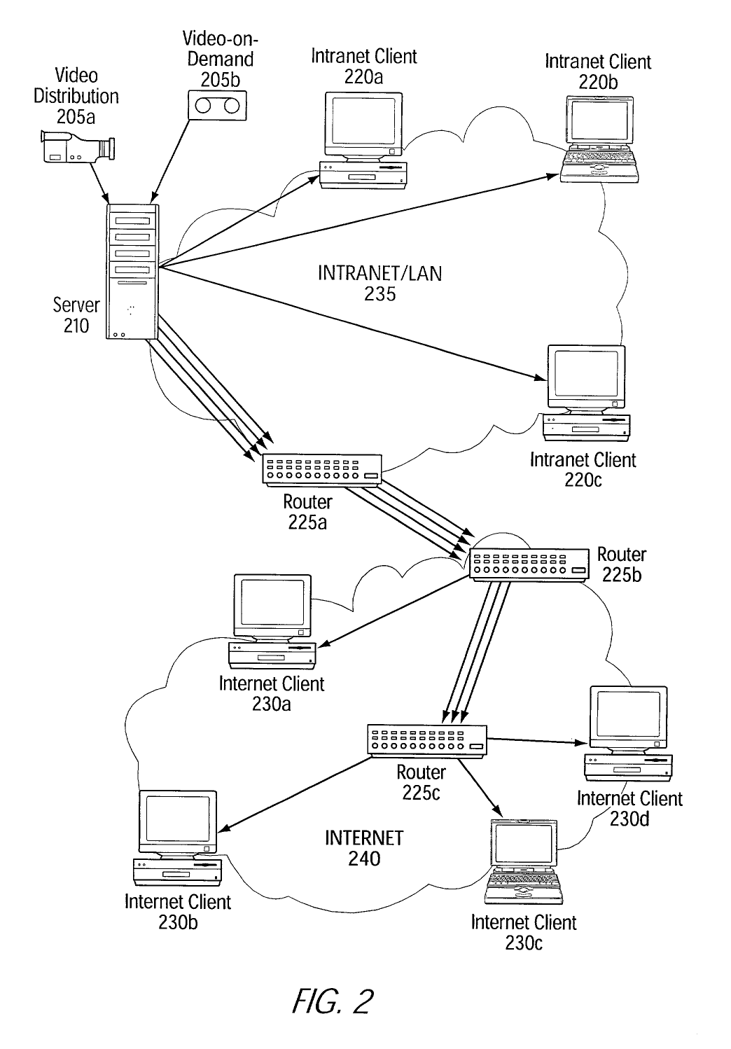

### DETAILED DESCRIPTION

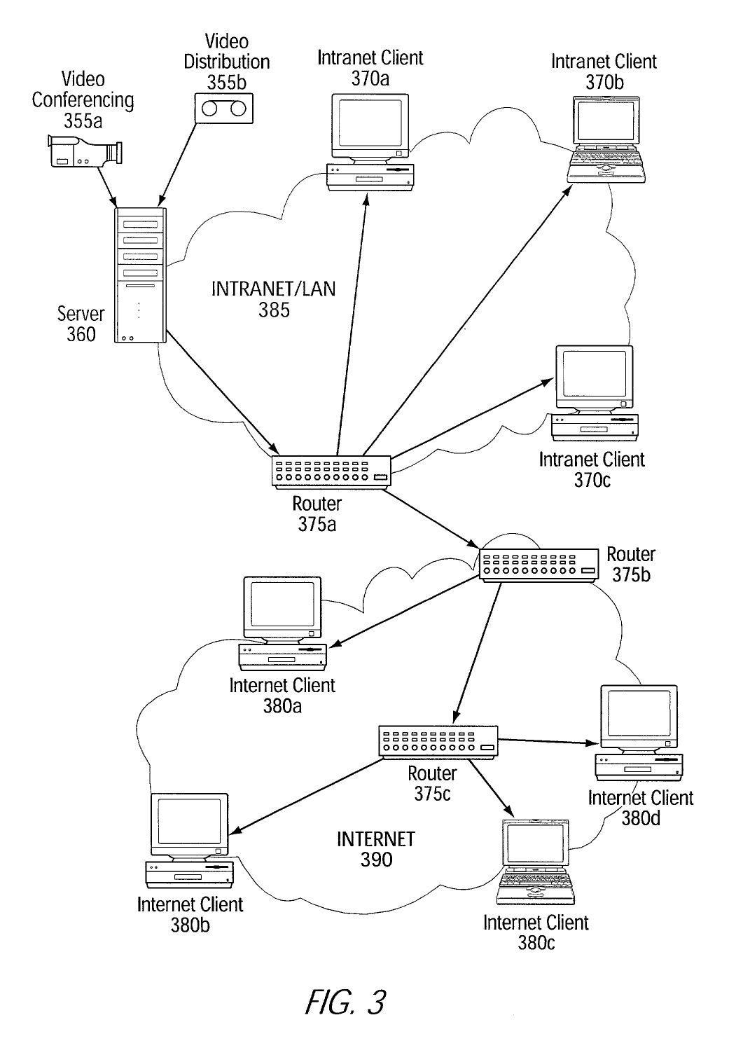

The present invention is a method and system for bridging multicast and unicast so that a unicast client may receive a multicast transmission. As previously explained, using conventional means, a client connected to a unicast intermediate system (e.g., an intermediate system such as a router that is not enabled to handle a multicast transmission) cannot receive a multicast transmission because the intermediate system is not capable of processing the multicast transmission. These clients are termed “unicast clients” because they are limited to unicast transmissions and cannot receive a multicast transmission. For example, in FIG. 3, if router 375c is not multicast-enabled, a client connected directly to the router (clients 380b- 380d) cannot receive a multicast transmission because the router 375c will not be able to process and forward the multicast transmission. The present invention solves this problem (as explained below) by using an agent (i.e., a network program) to convert the multicast packets in the transmission into unicast packets which are then transmitted to the unicast client. This solution is different than the previously described tunneling whereby a multicast packet is encapsulated in a unicast packet to skip over one or more nonmulticast-enabled routers. A tunnel is a point-to-point link enabling the routing of multicast packets between two intermediate systems separated by routers that do not support multicasting (referred to hereafter as “unicast routers”). Tunneling involves the delivery of an encapsulated multicast packet from one multicast-enabled router (“multicast router”) over one or more unicast routers to another multicast router that removes the unicast encapsulation and continues forwarding the multicast packet. During tunneling, a unicast router is not a recipient and merely forwards the unicast packet (i.e., the encapsulated multicast packet) onwards toward a second multicast router. The present invention is different from tunneling in that the agent directs a multicast packet to a unicast end recipient thereby appending unicast transmission paths to the multicast transmission. This is not the same thing as the temporary bridge along the multicast transmission path that tunneling accomplishes.

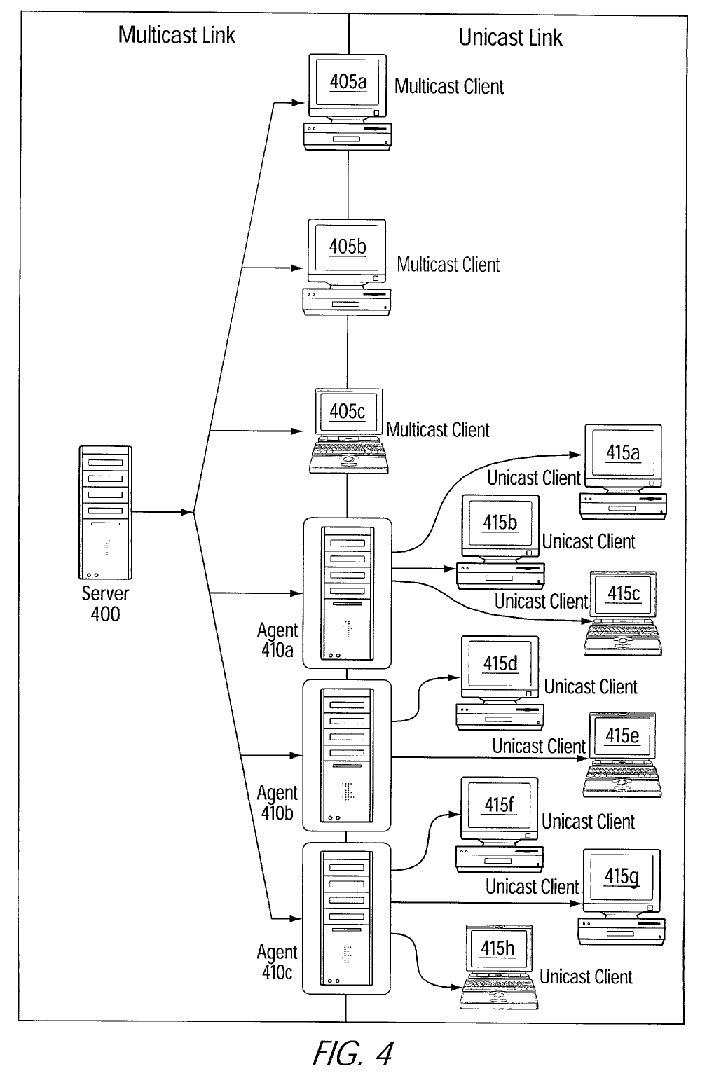

FIG. 4 is a diagram illustrating the transmission of a multicast packet or message according to one embodiment of the present invention. The server 400 initiating the multicast transmission sends a single stream of multicast packets that is forwarded by routers and other intermediate systems (not shown) over the communications network to multicast-enabled clients 405a-405c, 410a-410c. Some of these multicast-enabled clients are the intended final recipients of the multicast transmission 405a-405c while others are agents (i.e., network programs) running on server computers that are multicast-enabled 410a-410c. These agents 410a-410c receive a multicast packet from the transmission and resend the packet as a separate unicast packet once for each unicast client. An individual unicast packet is sent over a separate point-to-point connection from the agent to each of the unicast clients that have joined the multicast group via the method provided by the present invention. Each of these unicast clients has an associated designated agent that is responsible for forwarding the packet to them. For example, when agent 410a receives a multicast packet, it may generate three separate unicast packets that may be sent to the unicast clients 415a-415c it is responsible for and who are recorded in the agent's recipient list. Similarly, agent 410b may receive a multicast packet which may then be used to generate associated unicast packets that are individually sent to the unicast clients 415d-415e in the agent's recipient list. Agent 410c may also generate unicast packets based on a received multicast packet and may individually send these unicast packets to each unicast client 415f-415h that it has been designated responsible for (these clients may be identified in the agent's recipient list).

### Source Server

The source server is a term for the one or more server programs that are enabled to process requests from unicast clients to join a multicast group according to one embodiment of the present invention. The source server also maintains information on all currently available agents so that it may designate one of the available agents to handle the multicast to unicast bridging for the unicast client that sends a request to join a multicast group according to one embodiment of the present invention. The agent information is maintained, according to various exemplary embodiments of the present invention, in a database, list, or table and is used by the source server when processing a request by unicast clients to join a multicast group (both client requests and the use of agents are discussed below). In an exemplary embodiment of the present invention, the source server is multicast-enabled though in alternative embodiments, the source server does not need to be multicast-enabled. The source server may be centralized on a single computer system or may be distributed and/or replicated across several computer systems according to various embodiments of the present invention.

The source server maintains information on the agents by updating the agent information when new agents are added or deleted from the communications network according to one embodiment of the present invention. According to one embodiment of the present invention, if the new agent is added by the source server to a multicast-enabled server computer on the communications network, the source server will have all the necessary information about the agent and may update the agent accordingly. According to another embodiment of the present invention, the new agent may send the source server a message informing the source server about the agent. For example, the agent may send the source server the agent's address and the agent's status such as ready to receive. In yet another embodiment of the current invention, the agent may periodically send the source server status messages allowing the source server to update its agent information on a periodic basis. Another embodiment of the present invention envisions the source server periodically polling the agents in order to obtain any updated information regarding the agent's status on the communications network.

### Agent

An agent is a network program that runs on a multicast-enabled computer that can be connected to a multicast network according to one embodiment of the present invention. If is the agent runs on a multicast-enabled computer, the source server must also run on a multicast-enabled computer. According to one embodiment of the present invention, the agent is a process that runs in the background on a server computer and waits to receive multicast packets for further forwarding to unicast clients. In the example embodiment, a unicast client may send a join message directly to the source server but in an alternative embodiment the join message may be sent to an agent. The agent may maintain a list of unicast clients (a recipient list) for whom it is responsible for providing bridging services according to one embodiment of the present invention. When an agent process is first started, the recipient list may be empty. In one embodiment of the present invention, when a new unicast client sends the source server a request to join a multicast group, the source server may designate a particular agent to handle the new unicast client. When an agent is designated to handle the multicast to unicast bridging for a client, the client's information may be added to that particular agent's recipient list. The client information maintained in the recipient list may, for example, include the client's address such as an IP address, a client data port number, a client control port number, connection parameters such as the bandwidth of the client and time-out settings, and statistics such as the number of packets sent. In one embodiment of the present invention, when a client decides to leave a multicast group, the client sends a leave message to its designated bridging agent (described below). The designated agent may then remove the client information from the recipient list. In an alternative embodiment of the present invention, the client may send the leave message to the source server.

### New Agent

A new agent is an agent process that is newly started on a server computer. A new agent may, according to one embodiment of the present invention, perform two important tasks at startup in order to be fully functional: 1) join the appropriate multicast group, and 2) become known to (i.e., register with) the source server. The agent, like any other potential multicast client, must join a multicast group before it can receive data from that group. According to one embodiment of the present invention, the agent may join the multicast group by issuing a conventional Internet Group Management Protocol (IGMP) join message. This join message may specify the agent's address and the multicast group it wants to join. According to one embodiment of the present invention, the router takes the agent's IGMP join message storing the agent information in the router's routing table, builds its own IGMP join message which it then transmits. For example, according to one embodiment of the present invention, the following IGMP join message may be sent by a router: “ip igmp join-group 225.2.2.2”. According to another embodiment of the present invention using another implementation of IGMP, the following IGMP join message may be sent by a router while in IGMP mode: “join 225.2.2.2”. In addition to joining the desired multicast group, the agent must also be known to the source server according to one embodiment of the present invention.

The source server may maintain current information on the agents by updating the agent information when new agents are added or deleted from the information system according to one embodiment of the present invention. This update of agent information may occur differently according to various embodiments of the present invention. For example, a first embodiment of the present invention may have the source server place the agent on a server computer and initiate the agent program. As part of this process, the agent information is known to the source server and the source server can immediately update its agent listing. In another example according to another embodiment of the present invention, the new agent may send the source server a message informing the source server about the agent, the agent's address, and the agent's status, such as ready to receive. In a third example according to another embodiment of the present invention, the agent may periodically send the source server a status message allowing the source server to update its agent information on a periodic basis. Another embodiment of the present invention envisions the source server periodically polling the agents in order to obtain any updated information regarding the agent's status on the communications network.

### New Client Joining Multicast Group

A new multicast client may join a multicast group using conventional means in the same manner that an agent may join a multicast group. New multicast clients and new agents may transmit an IGMP join message as previously discussed. The IGMP join message is processed by the multicast routers and the new client (or new agent) is added to the distribution tree of the multicast group in a conventional manner.

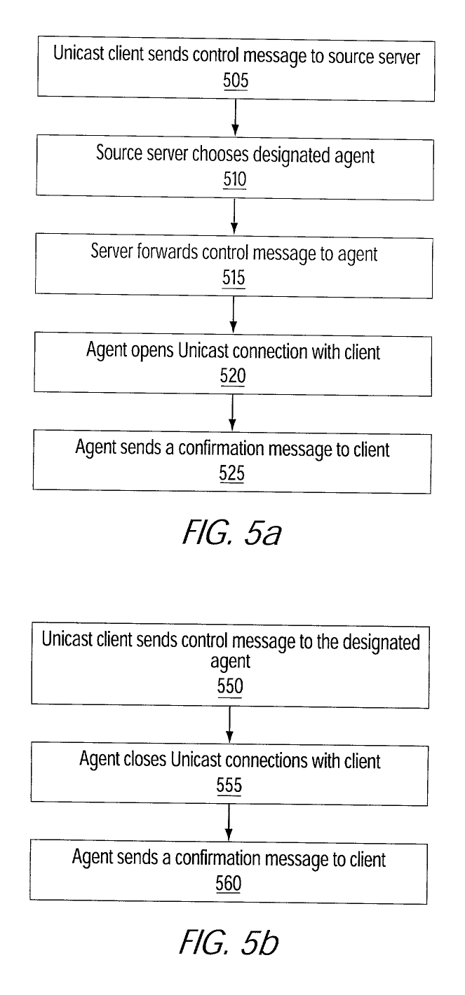

FIG. 5a is a block diagram illustrating the process whereby a unicast client may join a multicast group according to one embodiment of the present invention. A unicast client may join a multicast group, according to one embodiment of the present invention, by sending a special “unicast join” control message 505 to a source server. The “unicast join” message is not conventional and is specific to the present invention. The source server, on receipt of the “unicast join” message, designates an agent 510 to handle the forwarding of multicast packets to the unicast client. According to one embodiment of the present invention, the agent is selected in order to optimize performance according to a composite distance metric (discussed below). In alternative embodiments of the present invention, other means for selecting the agent (e.g., server load) may be used. Once the source server selects the agent to handle the forwarding of multicast packets to the unicast client, the source server forwards the client's “unicast join” message 515 to the designated agent according to one embodiment of the present invention. In another embodiment of the present invention, the source server may generate a separate message that is sent to the designated agent. The designated agent may open a unicast connection with the client by storing the client's information in a recipient list maintained by the agent 520. The designated agent may then send a confirmation message to the unicast client 525 telling the client that its join to the multicast group was successful. In the event that a the client's attempt to join the unicast group is unsuccessful, a confirmation message may not necessarily be sent. According to one embodiment of the present invention a message may be sent to inform the client about the unsuccessful nature of the unicast join to a multicast group or, according to an alternative embodiment, the lack of a confirmation message may serve as an indicator that the client's attempt to join the multicast group failed. Once a unicast client has joined a multicast group, multicast packets sent to that multicast group are forwarded to the client using the agent as an intermediary.

In an alternative embodiment of the present invention, a unicast client may send the “unicast join” message to an agent. In this alternative embodiment, the agent may forward the “unicast join” message to the source server with either the agent becoming the designated agent for the unicast client or with the source server determining the designated agent as outlined above.

### Client Leaving Multicast Group

FIG. 5b is a block diagram illustrating the process whereby a unicast client may leave a multicast group according to one embodiment of the present invention. A unicast client may leave a multicast group , according to one embodiment of the present invention , by sending a special “unicast leave” control message 550 to the designated agent. The “unicast leave” message is not conventional and is specific to the present invention. On receipt of the “unicast leave” message 550, the designated agent may close the unicast connection with the client by removing the client from the recipient list 555 maintained by the designated agent. The designated agent may then send a confirmation message to the unicast client 560 telling the client that its attempt to leave the multicast group was successful. In the event that a client's attempt to leave the unicast group is unsuccessful, a confirmation message may not necessarily be sent. According to one embodiment of the present invention a message may be sent to inform the client about the unsuccessful attempt to leave a multicast group or, according to an alternative embodiment, the lack of a confirmation message may serve as an indicator that the client's attempt to leave the multicast group failed.

In an alternative embodiment of the present invention, a unicast client may leave a multicast group by failing to respond to a multicast group query either initiated by a router or initiated by an agent. For example, a CISCO multicast router may periodically transmit a client membership query message in order to determine which multicast groups have members on the router's attached networks. As a multicast client, the agent will be a multicast member on a router's attached networks, such as a CISCO router's attached network as mentioned in the example. This router query message may cause the agent to poll or query its attached clients (i.e., the unicast clients for whom the agent has been designated to provide multicast service). If an attached unicast client does not respond to the agent's query message, the agent may stop forwarding multicast packets to the client. If an attached unicast client responds to the agent's query message but does not include a multicast group in its response message, the agent may stop forwarding multicast packets from the omitted multicast group to the client. Where a router query message causes an agent to poll or query its attached clients, the agent may respond to the router query message according to the responses the agent received from its attached clients. In this example, the agent may respond using an IGMP report message to let the router know which multicast groups it wants to receive packets from. The agent may also periodically, without initiation by a router membership query message, poll or send a query to its attached unicast clients to determine which multicast groups the agent needs to belong to and to whom the agent needs to forward information from those multicast groups.

### Agent Designation and the Composite Distance Metric

According to one embodiment of the present invention, when a unicast client joins a multicast group, the source server designates an agent to handle the multicast to unicast bridging for the client. Agents may be geographically distributed to assist with the bridging service and to take greatest (or greater) advantage of multicasting until the multicast packets are geographically close to the unicast client. If no appropriate agent is available, the source server may take the initiative to start a new agent process at an appropriate geographic location according to one embodiment of the present invention. The source server, in one embodiment of the present invention, may determine if an appropriate agent is available and may select an agent to be designated to handle the multicast to unicast bridging services for a unicast client by using a composite distance metric. A composite distance metric may be a measurement between a single client and a single agent that may take into account the number of network hops, the expected delay between the agent and the client, and the current load on the agent.

According to one embodiment of the present invention, the composite distance metric calculations between a client and an agent are stored in a composite metric index at the source server. In one embodiment of the present invention, a composite distance metric calculation may be stored for each client/agent pair. In alternative embodiments of the present invention, a single CDM calculation may be stored per client and/or a CDM calculation may be stored for neighboring client/agent pairs (i.e., geographically close client/agent pairs). The composite distance metric calculations may be constantly updated and are used to make decisions on the routing and rerouting of a client to an agent according to one embodiment of the present invention. For example, if the demand for agent bridging services increases at a geographic location, new agents may be dynamically added by the source server. The composite distance metric calculations may be updated and new calculations for the additional agents may be added to the composite index at the source server. The source server may use the updated composite distance metric calculations to reroute clients from overloaded agents to the newly added agents according to one embodiment of the present invention. A source server may, according to one embodiment of the present invention, reroute a client by issuing a “unicast leave” message to the original designated agent (the designated agent before rerouting) for the client and by issuing a “unicast join” message to the newly designated agent (after rerouting) for the client.

According to one embodiment of the present invention, the composite distance metric is calculated using the following formula:

d(c,a)=A*h(c,a)+B*(a)+C*c(c,a)

In the example formula, d(c, a) is the composite distance between client c and agent a using a standard measurement consistent with all composite distance metric calculations. A, B, and C represent adjustable constants that are used to weight the various portions of the formula as necessary for optimizing or adjusting the composite distance metric calculations. The h(c, a) value represents the number of hops between client c and agent a. For example, each hop is an intermediate system, such as a router, that lies on the path between the client and the agent. The l(a) value is the load factor on agent a and may be either a fraction or decimal. The c(c, a) value represents the cost of the link between client c and agent a. In an alternative embodiment of the present invention the h(c,a) value may represent a latency value instead of the number of hops. The latency value should use a standard measurement consistent with all composite distance metric calculations in this alternative embodiment in order to allow accurate comparisons of the composite distance values.

What is claimed is:

1. A method for transmitting information to a client over a communications network, comprising the steps of:
registering the client with an agent at a multicast-enabled computer;
receiving, by the multicast-enabled computer, a multicast data item;
generating a unicast data item as a function of the received multicast data item; and
transmitting, by the agent, the unicast data item to the registered client.

2. The method according to claim 1, wherein the communications network is the Internet.

3. The method according to claim 1, the registering step further comprising the steps of:
generating, by the client, a request to join a multicast group;
transmitting the generated request to a source server;
maintaining, by the source server, a list of available agents;
designating, by the source server, an agent to provide service to the client; and
assigning, by the source server, the client to the designated agent.

4. The method according to claim 3, wherein the source server is distributed over a plurality of computer systems.

5. The method according to claim 1, the registering step further comprising the steps of:
generating, by the client, a request to join a multicast group;
transmitting the generated request to a source server;
maintaining, by the source server, a list of available agents;
determining a composite distance metric for a client/agent pair;
designating, by the source server, an agent to provide service to the client as a function of the composite distance metric for the client/agent pair; and
assigning, by the source server, the client to the designated agent.

6. The method according to claim 5, wherein the source server is distributed over a plurality of computer systems.

7. The method according to claim 1, further comprising:
determining a composite distance metric for a client/agent pair.

8. The method according to claim 7, the registering step further comprising:
registering the client with an agent at a multicast-enabled computer as a function of the composite distance metric.

9. The method according to claim 1, the registering step further comprising the steps of:
generating, by the client, a request to join a multicast group;
transmitting the generated request to the agent at a multicast-enabled computer; and
adding, by the agent, the client to a list of unicast recipients serviced by the agent.

10. The method according to claim 1, the registering step further comprising the steps of:
generating, by the client, a request to join a multicast group;
transmitting the generated request to a primary agent at a multicast-enabled computer;
maintaining, by the primary agent, a list of available agents;
designating, by the primary agent, a service provider agent to provide service to the client; and
assigning, by the primary agent, the client to the designated service provider agent.

11. The method according to claim 1, the registering step further comprising the steps of:
generating, by the client, a request to join a multicast group;
transmitting the generated request to a primary agent at a multicast-enabled computer;
maintaining, by the primary agent, a list of available agents;
determining a composite distance metric for a client/agent pair;
designating, by the primary agent, a service provider agent to provide service to the client as a function of the composite distance metric for the client/agent pair; and
assigning, by the primary agent, the client to the designated service provider agent.

12. The method according to claim 1, further comprising the step of:
storing client information with the agent as a function of the registering step.

13. The method according to claim 12, the generating step further comprising the steps of:
retrieving a destination address for the client from the stored client information; and
creating a unicast data packet wherein the destination address of the unicast data packet is the retrieved client destination address.

14. A system for transmitting multicast information to a client over a communications network, comprising:
a client, wherein the client is a computer program handling the delivery of multicast information to a user;
an agent, wherein the agent is a computer program receiving multicast information and distributing the multicast information to the client using a unicast transmission;
a source server, wherein the source server is a computer program managing the assignment of the client to the agent;
a computing device including at least one of:
a program memory, wherein the program memory is adapted to hold some portion of at least one of a source server, the agent, and the client;
a storage device, wherein the storage device contains at least one of the source server, the agent, and the client; and
a processor, wherein the processor is adapted to at least one of:
(i) load, from the storage device, some portion of at least one of the source server, the client, and the agent into the program memory;
(ii) register the client with the agent at a multicast-enabled computer;
(iii) receive, by the multicast-enabled computer, a multicast data item;
(iv) generate a unicast data item as a function of the received multicast data item; and
(v) transmit, by the agent, the unicast data item to the registered client.

15. The system according to claim 14, wherein the communications network is the Internet.

16. The system according to claim 14, wherein the processor is further adapted to:
generate, by the client, a request to join a multicast group;
transmit the generated request to the source server;
maintain, by the source server, a list of available agents;
designate, by the source server, an agent to provide service to the client; and
assign, by the source server, the client to the designated agent.

17. The system according to claim 14, wherein the processor is further adapted to:
generate, by the client, a request to join a multicast group;
transmit the generated request to the source server;
maintain, by the source server, a list of available agents;
determine a composite distance metric for a client/agent pair;
designate, by the source server, an agent to provide service to the client as a function of the composite distance metric for the client/agent pair; and
assign, by the source server, the client to the designated agent.

18. The system according to claim 14, wherein at least two of the client, the agent, the source server are stored and operate on at least two separate computing devices.

19. A medium storing instructions adapted to be executed by a processor to perform the steps of:
registering a client with an agent at a multicast-enabled computer;
receiving, by the multicast-enabled computer, a multicast data item;
generating a unicast data item as a function of the received multicast data item; and
transmitting, by the agent, the unicast data item to the registered client.

20. A method for receiving by a client information over a communications network, comprising the steps of:
registering, by the client, with an agent at a multicast-enabled computer; and
receiving, from the agent, a unicast data item, wherein the unicast data item is generated as a function of a multicast data item sent to a multicast group.

21. The method according to claim 20, wherein the communications network is the Internet.

22. The method according to claim 20, the registering step further comprising the steps of:
generating, by the client, a request to join a multicast group;
transmitting the generated request to a source server;
designating, by the source server, the agent to provide service to the client; and
assigning, by the source server, the client to the designated agent.

23. The method according to claim 22, the registering step further comprising the step of:
maintaining, by the source server, a list of available agents.

24. The method according to claim 22, wherein the source server is distributed over a plurality of computer systems.

25. The method according to claim 20, the registering step further comprising the steps of:
generating, by the client, a request to join a multicast group;
transmitting the generated request to the agent at a multicast-enabled computer; and
adding, by the agent, the client to a list of unicast recipients serviced by the agent.

26. The method according to claim 20, the registering step further comprising the steps of:
generating, by the client, a request to join a multicast group;
transmitting the generated request to a primary agent at a multicast-enabled computer;
designating, by the primary agent, a service provider agent to provide service to the client; and
assigning, by the primary agent, the client to the designated service provider agent.

27. The method according to claim 26, the registering step further comprising the step of:
maintaining, by the primary agent, a list of available agents.

28. The method according to claim 20, further comprising the step of:
storing client information with the agent as a function of the registering step.

29. The method according to claim 28, the receiving step further comprising:
receiving, from the agent, a unicast data item, wherein the unicast data item is generated as a function of a multicast data item sent to a multicast group and a destination address for the client in the stored client information with the agent.

30. A system for receiving multicast information over a communications network, comprising:
a client, wherein the client is a computer program handling the receiving of the multicast information for a user;
an agent, wherein the agent is a computer program distributing the multicast information to the client using a unicast transmission;
a computing device including at least one of:
a program memory, wherein the program memory is adapted to hold some portion of at least one of the client and the agent;
a storage device, wherein the storage device contains at least one of the client and the agent; and
a processor, wherein the processor is adapted to at least one of:
(i) load, from the storage device, some portion of at least one of the client, and the agent into the program memory;
(ii) register the client with the agent; and
(ii) receive, from the agent, a unicast data item, wherein the unicast data item is generated as a function of a multicast data item sent to a multicast group.

31. The system according to claim 30, wherein the communications network is the Internet.

32. The system according to claim 30, wherein the processor is further adapted to at least one of:
generate, by the client, a request to join the multicast group;
transmit the generated request to a source server;
designate, by the source server, the agent to provide service to the client; and
assign, by the source server, the client to the designated agent.

33. The system according to claim 30, wherein the client and the agent are stored and operate on at least two separate computing devices.

34. A method for registering a unicast client with an agent at a multicast-enabled computer, comprising the steps of:
generating, by the unicast client, a request to join a multicast group;
transmitting the generated request to the agent at the multicast-enabled computer; and
adding, by the agent, the unicast client to a list of unicast recipients serviced by the agent.

35. A method for registering a unicast client with an agent at a multicast-enabled computer, comprising the steps of:
generating, by the unicast client, a request to join a multicast group;
transmitting the generated request to a source server;
designating, by the source server, the agent to provide service to the unicast client; and
assigning, by the source server, the client to the designated agent.

36. The method according to claim 35, further comprising the step of:
maintaining, by the source server, a list of available agents.

37. The method according to claim 36, wherein the list of available agents is at least one of a database and a table containing information about the agents.

38. The method according to claim 3 5, wherein the source server is distributed over a plurality of computer systems.

39. A method for registering a unicast client with an agent at a multicast-enabled computer, comprising the steps of:
generating, by the unicast client, a request to join a multicast group;
transmitting the generated request to a primary agent at a multicast-enabled computer;
designating, by the primary agent, a service provider agent to provide service to the unicast client; and
assigning, by the primary agent, the unicast client to the designated service provider agent.

40. The method according to claim 39, further comprising the step of:
maintaining, by the primary agent, a list of available agents.

41. The method according to claim 40, wherein the list of available agents is at least one of a database and a table containing information about the agents.

42. A method for maintaining, over a communications network, an agent list by a source server, the agent list containing information about at least one agent, the agent handling the sending of multicast transmission data to a client, the client not being able to receive a multicast transmission directly, comprising the steps of:
sending, by the agent, a status message to the source server on a periodic basis; and
updating the agent list as a function of the status message.

43. The method according to claim 42, wherein the communications network is the Internet.

44. The method according to claim 42, wherein the agent list is at least one of a database and a table containing information about the agent.

45. A method for maintaining, over a communications network, an agent list by a primary agent, the agent list containing information about at least one other agent, the other agent handling the sending of multicast transmission data to a client, the client not being able to receive a multicast transmission directly, comprising the steps of:
sending, by the other agent, a status message to the primary agent on a periodic basis; and
updating the agent list as a function of the status message.

46. The method according to claim 45, wherein the communications network is the Internet.

47. The method according to claim 45, wherein the agent list is at least one of a database and a table containing information about the other agent.

48. A method for maintaining, over a communications network, an agent list by a source server, the agent list containing information about at least one agent, the agent handling the sending of multicast transmission data to a client, the client not being able to receive a multicast transmission directly, comprising the steps of:
polling, by the source server, the agent to obtain a status data item for the agent; and
updating the agent list as a function of the status data item.

49. The method according to claim 70, wherein the communications network is the Internet.

50. The method according to claim 48, wherein the agent list is at least one of a database and a table containing information about the agent.
